(19) United States
(12) Patent Application Publication
(10) Pub. No.: US 2012/0023770 A1
(43) Pub. Date: Feb. 2, 2012

(54) TUMBLE AIR DRYER

(76) Inventor: James Anthony Doubtfire, Sussex (GB)

(21) Appl. No.: 13/254,850

(22) PCT Filed: Jan. 27, 2010
(86) PCT No.: PCT/GB2010/050119

§ 371 Date: Sep. 4, 2011

(30) Foreign Application Priority Data
Mar. 4, 2009 (GB) 0903707.8

(51) Int. Cl. F26B 11/02

(52) U.S. Cl. 34/108

(57) ABSTRACT

A tumble air dryer (10) comprises an rotatable container (12) which is unenclosed and thus open to the environment and which is adapted for holding clothes, a support (14) for rotatably supporting the container (12) for rotation at only one side of the container (12), and drive means (46) for rotating the container (12) on the support (14). The container has at least one air permeable side (36, 40), and is removably mountable on the support (14) so that it can double as a washing basket and be easily transported between a washing machine and the support. Preferably, a plurality of containers (12) of different sizes are provided so that the container (12) to be attached to the support (14) can be selected based on a washing load.

The present invention relates to a tumble air dryer, particularly but not exclusively for outside location.

Clothes lines, including rotary clothes lines, are well known and useful for drying outside. However, these devices take time to hang wet washing on, and washing can often fall on the ground especially in strong winds. Furthermore, a clothes line provides no protection against sudden rain showers, thereby resulting in the clothes becoming wet and often dirty again.

Indoor clothes horses are also well known. Again, these devices have similar problems to those of the outdoor clothes lines in that space has to be available for the washing and it takes a reasonable amount of time to hang. Furthermore, with no exposure to ambient air and conditions, such as wind, the clothes can take far longer to dry. The increased moisture and humidity within the room from the drying clothes can also lead to damp and mould problems.

Indoor electric tumble dryers are known, and are used to more quickly dry clothes. However, these devices consume significant amounts of electrical energy for heating, and are thus expensive to run and environmentally unfriendly.

The invention seeks to provide a solution to this problem.

According to the present invention, there is provided a tumble air dryer comprising an unenclosed rotatable container for holding clothes and having at least one air permeable side, a support for supporting the container for rotation at only one side of the container, the container being removably mountable on the support, and drive means for rotating the container on the support.

Preferable and/or optional features of the invention are set forth in claims 2 to 19 inclusive.

The invention will now be more particularly described, by way of example only, with reference to the accompanying drawings, in which:

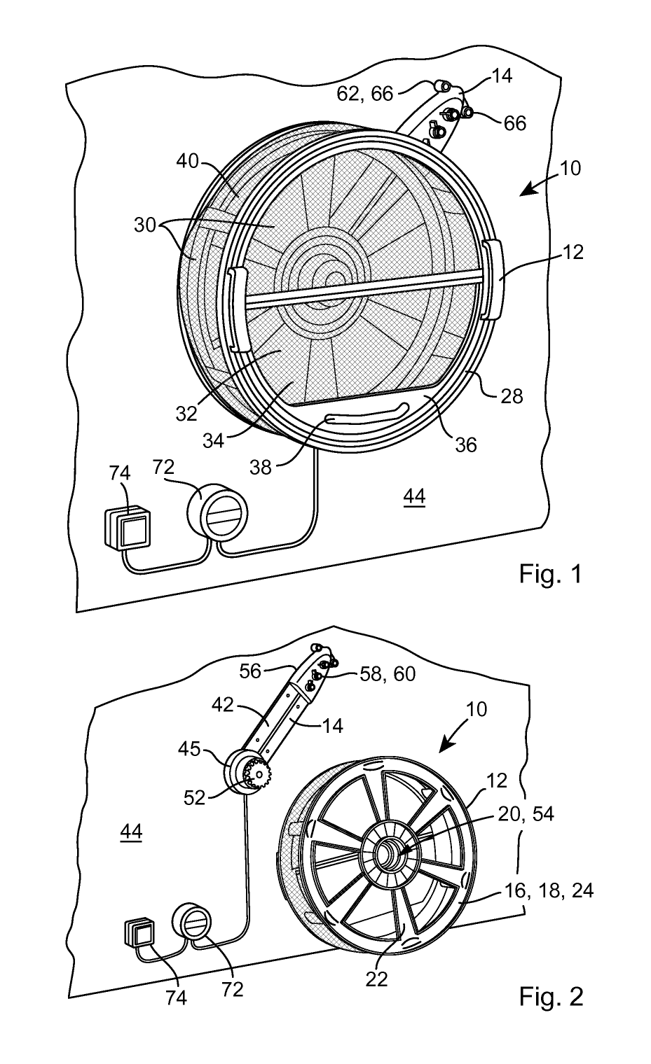

FIG. 1 is a perspective view of one embodiment of a tumble air dryer, in accordance with the invention;

FIG. 2 shows a back side of a container of the tumble air dryer detached from a support;

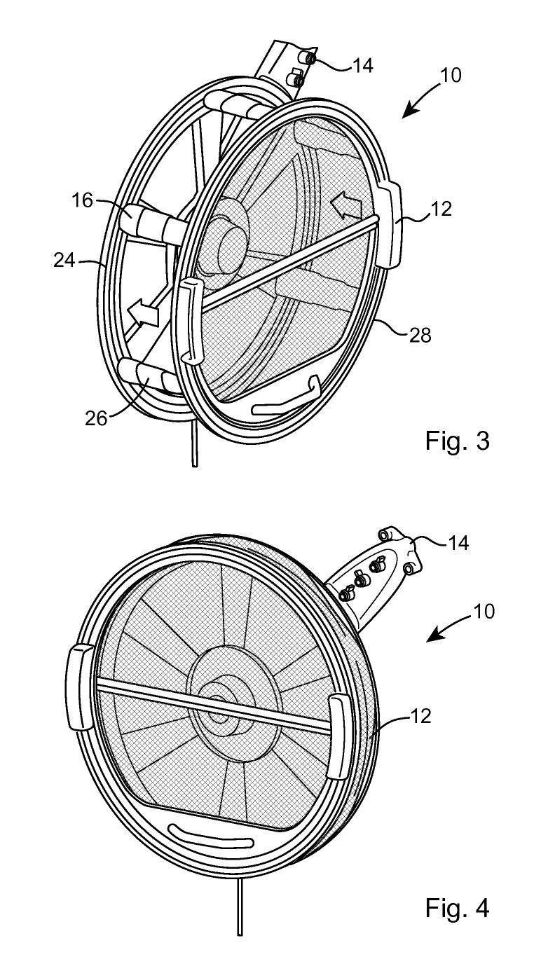

FIG. 3 shows a perspective side view of a framework of the container;

FIG. 4 shows the container of the tumble air dryer when collapsed for storage;

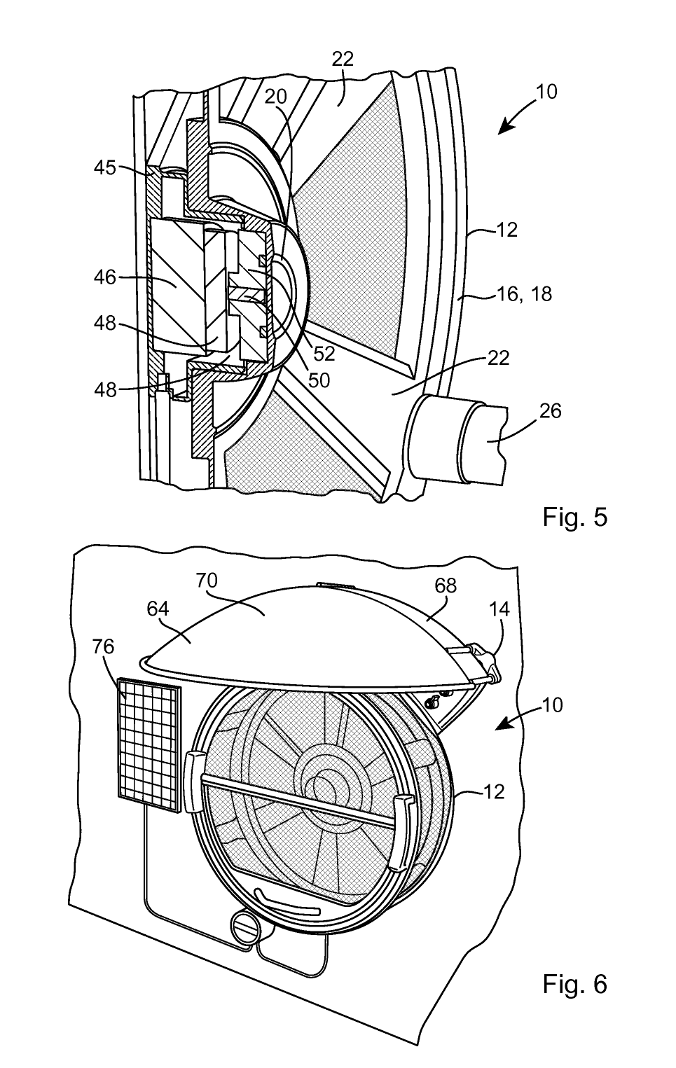

FIG. 5 is an enlarged partial cross-sectional view through a centre of the container and part of the support; and

FIG. 6 shows the tumble air dryer with a removable cover.

Referring to the drawings, there is shown a tumble air dryer 10 which comprises an unenclosed container 12, and a wall-mountable support 14 for rotatably supporting the container 12. The container 12 includes a framework 16 having a base 18 with a hub 20 and equi-angularly spaced elongate coplanar rigid spokes 22 which extend equi-distantly radially therefrom, a continuous circular back rim 24 which interconnects the distal ends of the spokes 22 remote from the hub 20, a plurality of equi-angularly spaced arm elements 26 which project in a common direction at right angles from the spokes 22, and a continuous circular front rim 28 which aligns or substantially aligns with the back rim 24.

The arm elements 26 are extendable and retractable, preferably being telescopic, so that the front rim 28 can be moved towards the back rim 24 to enable the container 12 to adopt a compact storage condition, and away from the back rim 24 to enable the container 12 to be used.

The framework 16 supports a pliantly flexible mesh skin 30 which, in this embodiment, covers the framework on all sides. Due to the mesh comprising a plurality of small apertures, the skin 30 is air permeable thus allowing the substantially free movement of air into and through the interior of the container 12. The skin 30 is also preferably removable from the framework 16 for cleaning and maintenance. For example, the back and front rims 24, 28 may include clipable portions for tightly or tautly engaging the mesh skin 30. With the skin 30 attached, the container 12 is cylindrical or substantially cylindrical.

The container 12 also includes an access opening 32 and an access cover 34 for closing the access opening 32. In this embodiment, the access opening 32 is in a front side or surface 36 of the container 12, and the access cover 34 is hinged at or substantially across the diameter of the container 12. The cover 34 preferably includes a handle 38 and releasable locking device for retaining the access cover 34 in a closed condition, for example, during use. A detent may also be included, typically at the hinge, to hold the access cover 34 open whilst washing is being loaded into or decanted from the container 12.

Although in a front surface 36, the access opening 32 and thus access cover 34 may be in a side 40 of the container 12.

Dependent on circumstances, two or more containers 12 of different volumes may be provided from which one can be selected dependent on necessity, such as an amount of washing requiring drying.

The support 14 comprises a rigid elongate arm 42 which is mountable to a wall surface 44 so as to be spaced from the ground. The arm 42 preferably has a longitudinal extent which is greater than a radius of the container 12 or the largest container 12 if a plurality is provided. One end 45 of the arm 42 houses an electric motor 46 with a high-torque gearbox 48 having an output shaft 50 with a spur gear 52 thereon. The output shaft 50 extends at right angles to the longitudinal extent of the arm 42. The hub 20 of the container 12 includes an opening 54 on its rotational axis which is complementarily shaped to receive and releasably engage the spur gear 52 as a push fit. A detent may be provided in the hub 20 and on the spur gear 52 to positively retain the container 12 thereon. For example, a pip and recess can be used.

The other end 56 of the arm 42 which is opposite the spur gear 52 includes a controller 58 having a user interface 60 for selecting, for example, a cycle duration, spin speed, and on/off.

The end of the arm 42 opposite the spur gear 52 also includes attachment means 62 for attaching a removable cover 64, as shown in FIG. 6. In this case, the attachment means 62 includes two openings 66 in which an arcuate support arm 68 of the cover 64 can be engaged. A cover element 70 projects from the arcuate support arm 68 so as to extend over and outwards beyond a top of the container 12. The cover 64 does not drop down the sides or over the front of the container 12 so as not to inhibit air flow.

To provide power to the electric motor 46, a mains powered transformer 72 is utilised. Preferably, an all weather switch 74, circuit breaker and transformer 72 are used to enable outside location of the tumble air dryer 10. However, if the dryer 10 is only to be used inside, the switch, circuit breaker and transformer need not be weather resistant. Furthermore, in this latter case, the circuit breaker may be dispensed with if the switch is fused.

Instead of or in addition to mains electrical power, a solar panel 76 can be utilised, as shown in FIG. 6, to provide electricity to the electric motor 46. It is also envisaged that any other suitable renewable energy collector could be used. For example, electricity could be provided by a wind turbine connected to a generator. As a further alternative, the electric motor could be dispensed with and the drive means could utilise only a wind turbine to move the container 12 without the use of electricity.

In use, the tumble air dryer 10 is typically provided as a kit of parts. The support 14 is mounted on a suitable wall 44 preferably facing the sun, and this may be outside. A further support 14 may be mounted on another wall, which may be inside or outside. The support 14 is connected to a mains power source, and the container 12 or a suitable sized container 12 selected from a plurality is fitted via its hub 20 to the spur gear 52 on the support 14. The container 12 is expanded if necessary, and loaded with washing to be dried. A cycle and duration is selected from the user interface 60, and the on/off button is operated to start the dryer 10. The container 12 is thus rotated whilst allowing the free or substantially free passage of air therethrough, providing ambient drying of the clothes.

Once the cycle is completed, the access cover 34 is opened, the washing removed, and the container 12 can be compacted to reduce space.

If a rain shower is expected or occurs, the removable cover 64 can be erected to protect the washing within the container 12.

The container 12 can be detached and moved to another one of the supports 14, for example, provided on a different exterior wall so as to track the sun's movement, or provided at an inside location.

It is preferable that all sides and faces of the container have walls which are air permeable to allow air to pass therethrough. However, it is possible that only one of the sides may be air permeable, such as the side or the front surface.

Although preferably compactable, the container may not be.

The container is a cylinder, but may be other shapes.

The container is not surrounded or enclosed, in order to allow free air movement thereacross, but the container itself is closed or closable to prevent washing from being unintentionally thrown therefrom during use.

Although wall-mountable, the support may be a pole or other free standing member, or the support may be attachable to such a free standing member.

It is thus possible to provide a tumble air dryer which, by having an unenclosed container, utilises the ambient temperature of the surrounding environment to dry washing. The tumble air dryer is compact and discreet, utilising far less space than a traditional clothes line or rotary washing line. By dispensing with an electric or gas powered heating element, the tumble air dryer is significantly more economical and environmentally friendly. The tumble air dryer also utilises few parts, allowing cost-effective manufacture and a long working life.

The embodiments described above are provided by way of examples only, and various other modifications will be apparent to persons skilled in the art without departing from the scope of the invention as defined by the appended claims.

1. A tumble air dryer comprising an apertured rotatable container which holds clothes and which has at least one air permeable side, a container-rotation support which rotatably supports the container on only one side, wherein the container is removably mountable on the container-rotation support, and a drive mechanism which rotates the container on the support.

2. A tumble air dryer as claimed in claim 1, wherein the support is wall-mountable.

3. A tumble air dryer as claimed in claim 1 or claim 2, wherein the container is expandable and collapsible to define a closed or closable selectably variable container volume.

4. A tumble air dryer as claimed in claim 1, wherein the at least one air permeable side is flexible.

5. A tumble air dryer as claimed in claim 1, wherein the at least one air permeable side includes a plurality of discrete apertures.

6. A tumble air dryer as claimed in claim 1, wherein the container includes a side wall, a front wall (36) and a rear wall which is adjacent to the support when the container is mounted thereon, at least the side and front walls being air permeable.

7. A tumble air dryer as claimed in claim 6, wherein the rear wall is air permeable.

8. A tumble air as claimed in claim 1, wherein the container includes a framework and mesh skin supported by the framework.

9. A tumble air dryer as claimed in claim 8, wherein the skin is removable from the framework.

10. A tumble air dryer as claimed in claim 1, wherein the container includes an access opening for user access of an interior of the container, and an access cover for closing the access opening.

11. A tumble air dryer as claimed in claim 1, further comprising at least one further said container having a different size, the in use container being selected from amongst the plurality of containers.

12. A tumble air dryer as claimed in claim 1, wherein the drive means includes an electric motor (46) provided in the support.

13. A tumble air dryer as claimed in claim 1, wherein the drive means includes a renewable energy collector.

14. A tumble air dryer as claimed claim 1, further comprising a cover for sheltering the container from the elements.

15. A tumble air dryer as claimed in claim 14, wherein the cover is detachably mountable on the support.

16. A tumble air dryer as claimed in claim 14, wherein the cover extends over the top of the container whilst leaving the majority of the front opposite the support and sides exposed.

17. A tumble air dryer as claimed in claim 1, wherein the container is cylindrical and has a diameter which is greater than its axial length.

18. A tumble air dryer as claimed in claim 1, wherein the support is a single elongate arm element.

19. A tumble air dryer as claimed in claim 18, wherein the container is rotatably mountable at or adjacent to one end of the arm element.

20. (canceled)
